(19) United States
(12) Patent Application Publication
(10) Pub. No.: US 2024/0385308 A1
(43) Pub. Date: Nov. 21, 2024

(54) TAG LOCATION METHOD AND APPARATUS

(71) Applicant: Wiliot, Ltd., Caesarea (IL)

(72) Inventors: Yoav IKAN, Hahotrim (IL); Yotam GOLANI, Tel Aviv-Yafo (IL); Alon YEHEZKELY, Haifa (IL)

(73) Assignee: Wiliot, Ltd., Caesarea (IL)

(21) Appl. No.: 18/640,652

(22) Filed: Apr. 19, 2024

Related U.S. Application Data
(60) Provisional application No. 63/502,538, filed on May 16, 2023.

(51) Int. Cl. G01S 13/75; G01S 13/87; G06K 7/10

(52) U.S. Cl. CPC G01S 13/758; G01S 13/878; G06K 7/10366

(57) ABSTRACT

A method for determining a location of a battery-less wireless tag by a tag reader being at a fixed-location. The method comprises: transmitting, by the tag reader, at least one wireless signal having a controlled known energy; receiving at the tag reader at least one packet transmitted by the tag within a time window; and responsive to a determination at the tag reader of at least one transmission rate of packets by the wireless tag based on the at least one received packet, determining information regarding the location of the tag.

### CROSS REFERENCE TO RELATED APPLICATIONS

This application claims the benefit of U.S. Provisional Application No. 63/502,538 filed on May 16, 2023, the contents of which are incorporated herein by reference.

### TECHNICAL FIELD

This invention relates to wireless tags, and more particularly, to determining the location of a wireless tag.

### BACKGROUND

It is well established that it is desirable to be able to locate wireless tags that are deployed in an environment. One methodology for doing so is the use of triangulation based on multiple values for the received signal strength indication (RSSI) for a tag when multiple wireless tag readers receive the signal transmitted by a single wireless tag, also referred to simply as a tag. Another methodology includes understanding which tag reader, which may be referred to herein simply as a reader, and is also known as a bridge, the terms being used interchangeably, detected which tag and using the RSSI of the signal from that tag as received at that reader to develop an approximation of the distance from the reader at which the tag is located.

Such methods are disadvantageous for tags that have noisy RSSI. Tags that have noisy RSSI include tags which operate according to the Bluetooth Low Energy (BLE) protocol. Such tags transmit with a bandwidth of 1 MHz around the carrier frequency and the BLE protocol operates using the 2.4 GHz industrial, scientific, and medical (ISM) spectrum band at a range of about 2.40 to 2.485 MHz. The RSSI is noisy because multiple readers read the tag, which creates zone bleeding. The RSSI signal is also noisy due to the fact that the 1 MHz signals are very sensitive to the radio frequency (RF) channel and the 2.4 GHz ISM channel is an environment in which signals are subject to high interference due to the presence of many transmitting devices. Furthermore, there is channel loss, also known as path loss, which is a loss of power supplied as output by the transmitting antenna versus what is received at the receiving antenna, i.e., at the end of the channel. Factors that go into causing channel loss include a reduction of power with distance which is further impacted by the multiple paths via which the signal arrives at the reader, e.g., due to reflections, antenna orientation of the tag, and other factors. Antenna gain and polarity also affect channel loss.

Also, for battery-less tags that have to harvest energy from an energizing signal transmitted by a reader, since the same reader is often used for energizing the tag and then receiving its transmitted signal, the deployment density of the readers is set based on the distance at which the tags can be provided via the wireless signal with enough energy for harvesting so that they can operate effectively or the distance at which the tag can be effectively calibrated. Thus, the deployment density of the readers is lower than the receiving distance. In other words, it is typically necessary to deploy the readers at a distance from the tags that enables providing sufficient energy to power the tags and such energy-providing distance is less than the distance at which the signal transmitted by the tags can be read. As such, it is insufficient to simply determine that a reader received a packet from a tag. Indeed, it is often the case that multiple readers can receive the signal transmitted by a single tag. Furthermore, in line with what was noted above, the RSSI at 2.4 GHz is highly affected by the channel conditions, so it cannot be used as a stand-alone solution.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a method for determining a location of a battery-less wireless tag by a tag reader being at a fixed-location. The method comprises: transmitting, by the tag reader, at least one wireless signal having a controlled known energy; receiving at the tag reader at least one packet transmitted by the tag within a time window; and responsive to a determination at the tag reader of at least one transmission rate of packets by the wireless tag based on the at least one received packet, determining information regarding the location of the tag.

Certain embodiments disclosed herein include a method for determining a location of a battery-less wireless tag with respect to at least one tag reader of a plurality of tag readers. The method comprises: transmitting by each of the plurality of tag readers an energizing signal for the battery-less wireless tag during each of a plurality of time windows, wherein the energizing signal transmitted by each respective one of the plurality of tag readers is transmitted with its own a prescribed energy, wherein each respective prescribed energy is zero or greater, wherein the prescribed energy of at least one of the energizing signals in at least one of the time windows is changed with respect to one of the time windows preceding the at least one of the time windows; and determining a location of the battery-less wireless tag based on a transmission rate of the battery-less wireless tag in each of at least two of the time windows which include the at least one of the time windows and the one of the time windows preceding the at least one of the time windows.

Certain embodiments disclosed herein include a method for determining a location a of battery-less wireless tag by correlating a transmission rate of the battery-less wireless tag with at least one change in the transmit power level of at least one energizing signal transmitted by a respective at least one tag reader.

Certain embodiments disclosed herein include a method for A method for determining a location of a mobile tag reader in an area containing a plurality of battery-less wireless tags that each have a known fixed location The method comprises: transmitting, by the mobile tag reader, during a time window, at least one wireless signal having a controlled known energy; receiving at the mobile tag reader at least one packet transmitted by each of one or more of the wireless tags within the time window; and responsive to a determination at the mobile tag reader of a transmission rate of packets from each of the one or more wireless tags of the plurality, which is based on the at least one packet received from each of the one or more of the wireless tags, determining a location of the mobile tag reader.

### BRIEF DESCRIPTION OF THE DRAWING

In the drawing:

FIG. 1 shows an illustrative time sequence for a location at three different times accordance with an embodiment;

FIG. 2 shows a graph containing an illustrative set of curves where each curve represents a tag's average transmitted packet rate versus channel loss;

FIG. 3 shows the rates of transmission detected for a tag when it is energized at various prescribed energies, the rates being superimposed on the graph of FIG. 2;

FIG. 4 shows three readers along with one tag;

FIG. 5 shows an arrangement including a mobile reader and several fixed-location tags;

FIG. 6 shows an illustrative graph representing channel loss between one reader and one tag at different frequencies, where each curve represents a different antenna orientation; and

FIG. 7 is an example schematic diagram of a system according to an embodiment that could be used to implement a reader or a server of a cloud environment for use in implementing the arrangements described herein.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in the plural and vice versa with no loss of generality. In the drawings, like numerals refer to like parts through several views.

In accordance with the principles of the disclosure, a battery-less wireless tag's location is determined based on the wireless tag's transmitting rate as correlated with a change in the transmit power level of at least one tag reader. In this regard, it should be appreciated that a battery-less wireless tag, which may be referred to herein generally as wireless tag, or simply tag, is a type of tag that only transmits upon harvesting sufficient energy to complete the operations necessary do so. Typically, once a battery-less wireless tag has accumulated sufficient energy for its processing function and transmission, it will transmit. Therefore, when there is less energy in the energizing signal supplied by the reader, which can be as a result of controlling the power transmitted by the reader and the distance of the tag from the reader, and indeed, a combination of both of these factors, there will be less energy harvested by the battery-less wireless tag, which will in turn take longer to accumulate sufficient energy for processing and transmission and hence will be able to transmit less often than when there is more energy in the energizing signal supplied by the reader. Effectively then, energy in, i.e., energy received by the wireless tag, correlates directly with transmission rate out of the tag.

As a result, for example, if a reader reduces the energy of its energizing signal or even stops transmitting its energizing signal, the tags in the area of such a tag reader which were employing the transmitted energy from such a reader will reduce their transmission rate because they take longer to harvest sufficient energy to transmit or they may not be able to charge at all. To this end, in accordance with an aspect of the disclosure, the power transmitted by one or more tag readers is controlled and the effect of the transmitted power on the transmission rate of various tags is monitored, and based thereon the location of the tags may be determined. It should be appreciated that because a single tag may receive energizing signals from multiple tag readers, even having a reader stop transmitting its energizing signal may not reduce to zero the transmission rate of any tag, even those close to that reader, because such tags may also be receiving energizing signals from other readers.

It should also be noted that the principles of the disclosure may be applied regardless of whether the tags are moving and the readers are stationary or whether the readers are moving and the tags are stationary.

The power of the energizing signal transmitted by the various readers may be changed in an iterative manner while the corresponding changes in tag transmission rates are observed and the location of any particular tag being determined based on the changes in the tag transmission rates. For example, in one embodiment, the location of a tag may be associated with the location of the reader to which the tag reacted the most, i.e., for which the tag demonstrated the greatest change in transmission rate when the power of that reader was changed. Thus, in one illustrative embodiment, when the power of all of the readers in a location are kept constant, except for one whose power is lowered, a tag in the vicinity of the reader that has its power lowered can be identified by such tag having a lowered transmission rate. Note that the reverse type of scenario may also be employed, i.e., where all the readers are kept at a constant power level, which may be zero, except for one reader which has an increased power level.

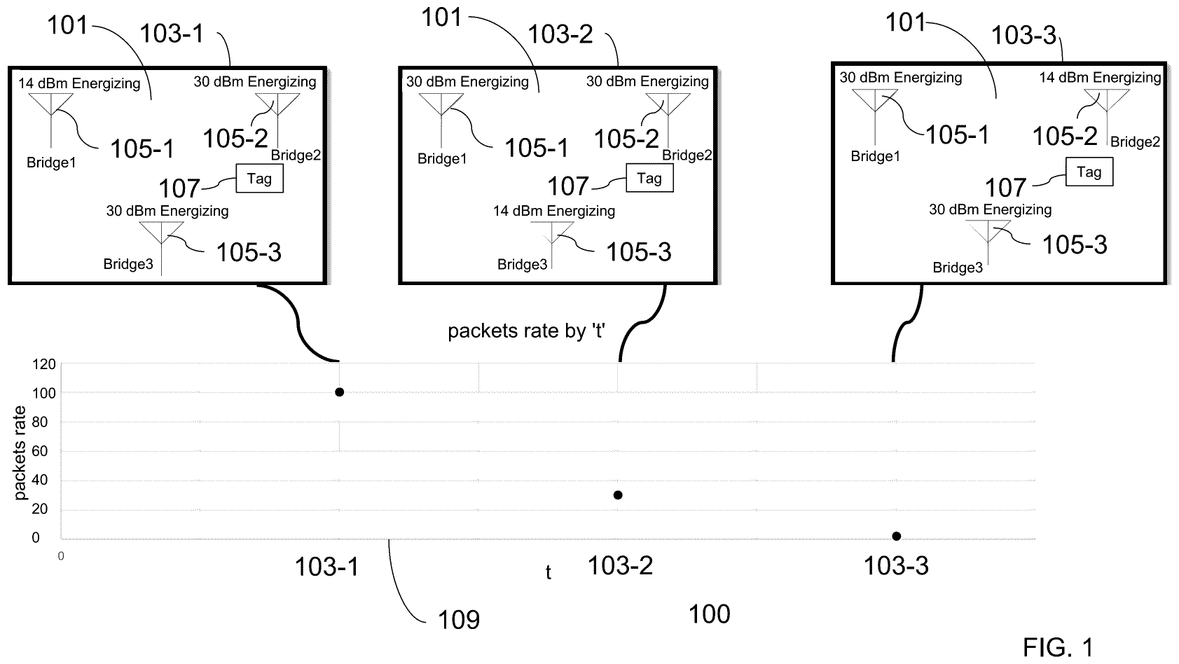

FIG. 1 shows an illustrative time sequence 100 for location 101 at three different times 103-1, 103-2, and 103-3 in accordance with an embodiment. Within location 101 there are three tag readers 105-1, 105-2, and 105-3, collectively referred to as readers 105 and individually as reader 105, which are also referred to as readers 105-1, 105-2, and 105-3, collectively referred to as readers 105 and individually as reader 105. In one embodiment, readers 105 may be coupled to each other for controlling the process of determining the location of battery-less, wireless tag 107, also referred to as wireless tag 107 or simply as tag 107. In another embodiment readers 105 may be coupled to a central computer (not shown) that controls the process of determining the location of tag 107. Graph 109 shows the rate of packets being transmitted by tag 107 along the Y-axis at times 103-1, 103-2, and 103-3, indicated along the X-axis. The purpose of the embodiment of FIG. 1 is to obtain a generalized idea of the location of tag 107 within location 101.

At each of times 103-1, 103-2, and 103-3 the power supplied by readers 105 is arranged differently. At time 103-1, reader 105-1 supplies a 14 dBm energizing signal while readers 105-2 and 105-3 each supplies a 30 dBm energizing signal. The result of this configuration is that tag 107 at the location shown in location 101 at time 103-1 transmits about 100 packets per unit time, e.g., second. At time 103-2, reader 105-3 supplies a 14 dBm energizing signal while readers 105-1 and 105-2 each supplies a 30 dBm energizing signal. The result of this configuration is that tag 107 at the location shown in location 101 at time 103-2 transmits about 30 packets per unit time, e.g., second. At time 103-3, reader 105-2 supplies a 14 dBm energizing signal while readers 105-1 and 105-3 each supplies a 30 dBm energizing signal. The result of this configuration is that tag 107 at the location shown in location 101 at time 103-3 transmits about 0 packets per unit time, e.g., second.

All else being equal, the worst transmission rate occurs when the power transmitted by the one of readers 105 closest to tag 107 is reduced. As the worst transmission rate is at time 103-3, where the power of reader 105-2 is only 14 dBM, this indicates that tag 107 is closest to reader 105-2.

As indicated above, a reverse type of scenario may also be employed, i.e., where all the readers are kept at a constant power level, which may be zero, except for one reader which has an increased power level relative to the constant power level of the other readers. The one of the readers having the increased power level is cycled through all of the readers. According to such a scenario, the one of readers 105 that produces the greatest transmission rate is deemed the one closest to tag 107. This approach maximizes the available energy in the area but makes it harder to identify the dominant one.

It must be appreciated that according to any scenario, there is the possibility for packets that are transmitted by tag 107 to not be properly received by one or more of readers 105. This may be due to interference on the channel or multipath reflections. As a result, an implementer should consider not only the number of packets actually received from tag 107 but the actual number of packets transmitted by tag 107. The actual number of tags transmitted by tag 107 may be deduced by taking into account the packet number included in each transmitted packet. For example, if a packet number of a first received packet is 84 and the next received packet number is 87, it can be deduced that even though only two packets were received, in actuality four packets were transmitted, i.e., packets 85 and 86 were transmitted but due to some circumstance, they were not received. Thus, in actuality, there was more energy available to the tag for transmission than would be thought to have been available based solely on the number of packets actually successfully received.

It should also be appreciated that a tag may be harvest energy from more than one frequency band. For example, a BLE tag may harvest energy not only at the BLE frequency but also at the sub 1 GHz frequency band. As such, the methodology of FIG. 1 may be extended so that the various bands that a tag is able to receive energy from are controlled and the resulting effect on the tag transmission rate determined.

The foregoing may be extended to determine the location of a tag more specifically, in the case of movable tags and fixed-location readers, or to determine the location of a reader more specifically in the case of fixed-location tags and movable readers. More specifically, by calculating a tag's transmission rate and knowing its transmission rate vs. channel loss characteristics the current channel loss can be assessed and the distance from the reader to the tag determined. Note that the channel loss here is the channel loss of the energizing signal transmitted from the reader, not the wireless communication signal transmitted from the tag.

Channel loss, i.e., the loss or reduction of power from the power that is supplied as input to the channel at the transmitting antenna as compared to the power that arrives at the receiving antenna, is affected by several factors, e.g., distance between the tag and the reader, the gain and polarity of the antennas of both the reader and the tag, the orientation of the antennas of the reader, and the actual quality of the channel. In one illustrative example, the power at the receiver when only the distance between the transmitter and receiver is taken into account, i.e., the antenna orientations and the effect of multipath on the channel are not taken into account, is given by:

$${P}_{rx} = {P}_{tx} + {G}_{tx} + {G}_{rx} + 20 {log}_{10} ( \frac{λ}{4 π {D}_{r}} )$$

where:
Pᵣₓ is the power received at the receiver, e.g., in dBm;
Pₜₓ is the transmitter output power, e.g., in dBm;
Gₜₓ is the transmitter antenna gain, e.g., in dB;
Gᵣₓ is the receiver antenna gain, e.g., in dBm;
λ is the wavelength, e.g., expressed in meters expressed; and
Dᵣ is the distance between antennas, e.g., expressed in meters.

The channel loss may then be represented as Pₜₓ−Pᵣₓ.

Based on a tag's transmission rate, it is possible to approximate the channel loss between the reader and the tag, and this would take into account the antenna orientations and the effect of multipath on the channel. A range between a tag and a reader may then be detected by linking a tag to the reader and determining the channel loss therebetween.

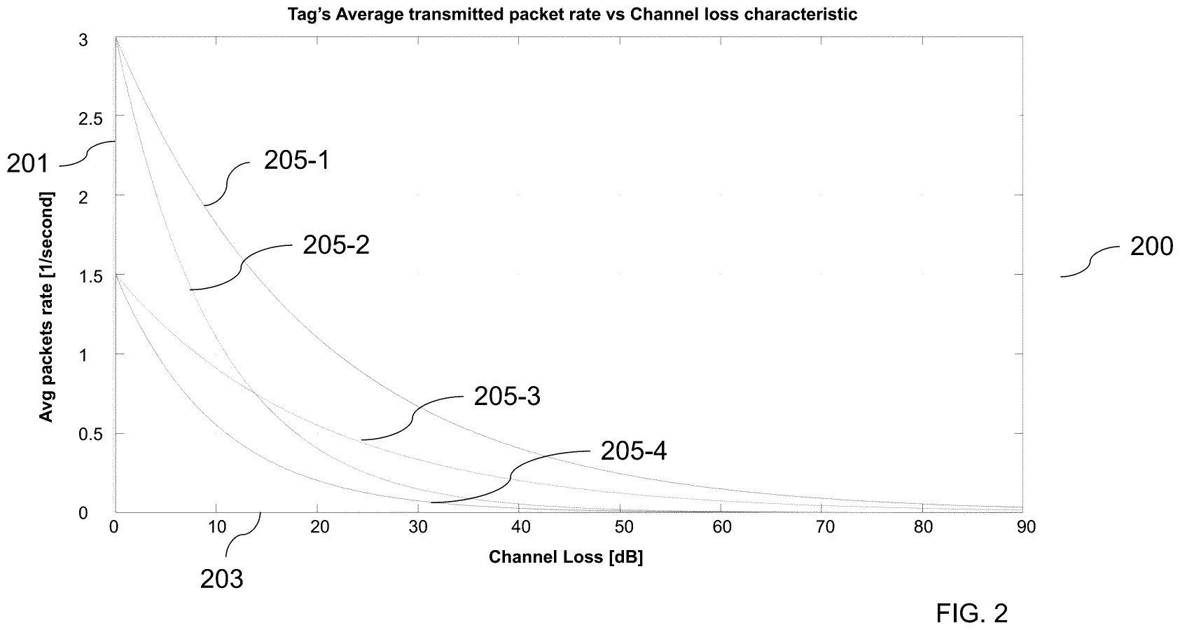

FIG. 2 shows graph 200 containing an illustrative set of curves 205-1 to 205-4, collectively curves 205, each representing a tag's average transmitted packet rate versus channel loss. In other words, each curve represents a transmission rate expected for a particular tag given the energy it receives. Y-axis 201 indicates the average packet rate, in terms of packets per second. X-axis 203 indicates the channel loss. Each of curves 205-1 to 205-4, represents a transmission rate expected for a particular tag (not shown) uniquely corresponding to the extension of the reference numeral 205, i.e., tag 1 to tag 4, given the energy it receives. When a tag's transmission rate vs. channel loss characteristic is known, then the current channel loss can be determined based on the tag's current transmission rate. When all of the other factors affecting channel loss can be treated as essentially constant, the channel loss is seen to be dependent on the distance between the reader and the tag. Thus, the distance between the reader and the tag may be determined based on the tag's rate of transmission.

The curve for a tag may be developed in at least one of several ways. According to one embodiment, the curves may be developed during the manufacturing process by supplying various power levels to a tag for a fixed period of time and determining how many packets are transmitted by the tag at each power level during that period. The test at each power level may be repeated several times and an average of the number of transmitted packets used for that power level. Of course, to find the rate, the number of packets is divided by the length of the period of time. In accordance with another embodiment, the curves may be developed using a calibration test in the field. The readers are placed in known location and a tag whose curve is to be developed is placed in a known location. Then, similar to the first embodiment, various known power levels are supplied for a period of time and the resulting number of packets transmitted for each period is determined. The test at each power level may be repeated several times and an average of the number of transmitted packets used for that power level. The rate of transmission is recorded by dividing the number of packets by the period of time.

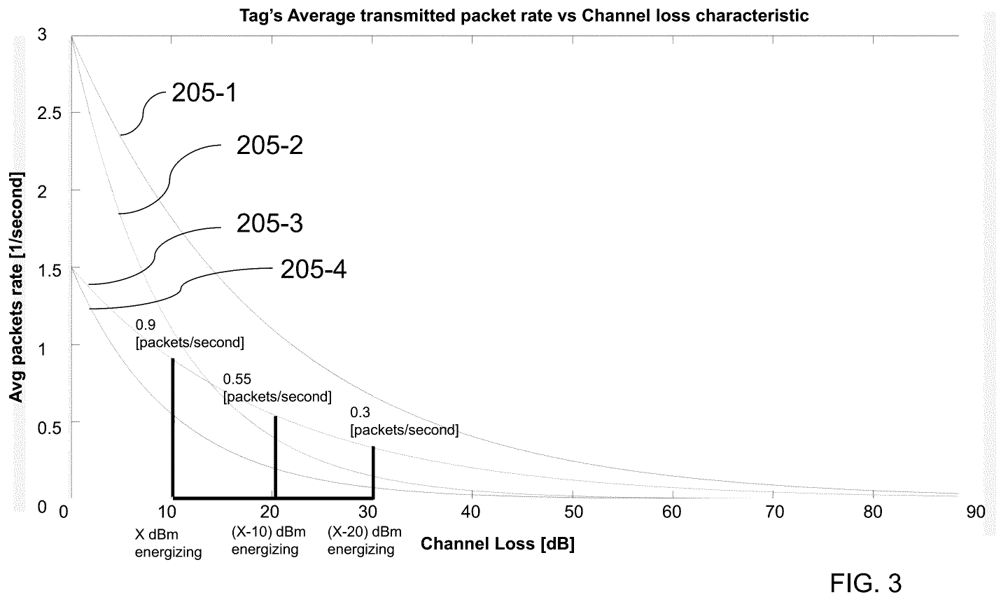

When a particular tag's transmission rate vs. channel loss characteristic is not known, although there are transmission rate vs. channel loss characteristics for other tags, the particular tag's characteristic can be estimated by using different energizing power levels with a known power difference between them to energize the tag and detecting the tag's transmission rate at those power levels. For example, shown in FIG. 3, superimposed on graph 200, are the rates of transmission detected for a tag when the tag is energized with X dBm, (X-10) dBm, and (X-20) dBm. Knowing the transmission rate, e.g., 0.9 packets per second, 0.55 packets per second, or 0.3 packets per second, the received signal strength indication (RSSI) at the input of the harvester can be determined from the X-axis.

Note that the RSSI of the receiving antenna, i.e., the antenna of a tag, is actually the output power of the transmitting antenna less the channel loss, where the output power of the transmitting antenna is the power supplied as output from the antenna of a reader. In the first instance, the output power of the reader's transmitting antenna is known, as it is under control of the reader, but the channel loss is unknown. Therefore, while it is not known where on the curve the measurements taken are, the gaps between the curves are known since the output power is controlled, and in the static use case, i.e., where neither the reader nor the tag is moving, it can be assumed that channel loss is permanent and constant. Therefore, the curve may be estimated by holding the channel loss unchanged, i.e., holding the reader and tag in their fixed location and keeping other environmental conditions the same, and simulating channel loss by changing the output power of the reader. This works because decreasing the output power of the reader has the same effect on the tag as increasing the channel loss. Thus, changing the output power of the reader simulates changes in channel loss. Note that the values on the X-axis are relative values in that one knows the difference in power supplied by the reader, which, in the example shown, are changed at 10 dBm intervals, but not the actual channel loss at the tag, which is not measured.

In one embodiment, the average packet rate vs. channel loss function can be defined as:

$$y = a \cdot {e}^{- b \cdot x + c}$$

where y is a tag's measured transmission rate, x is the RSSI of the energizing signal at the tag's harvester, which can be approximated by the transmitted power from the reader, which, as noted, is changed over known intervals, and a, b and c are unknown variables that should be estimated based on a set of different measurements that are obtained when changing reader's output power. Parameters calculation can be done by RANSAC or any other parameter optimization algorithm. As indicated above, based on the tag's transmission rate, e.g., number of packets transmitted per time window, it is possible to determine the tag's relative distance from a reader. When there are several readers with known locations, the tag's location may be determined by triangular interpolation. Again, as indicated above, when changing one of the reader's energizing power, the other readers' energizing power should each be held constant.

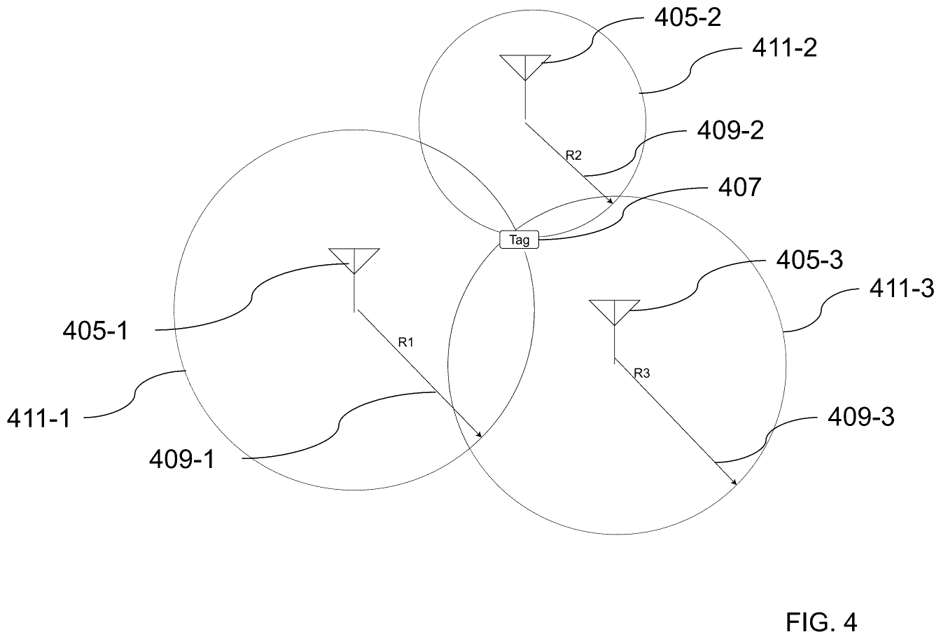

FIG. 4 shows three readers 405-1, 405-2, and 405-3, collectively readers 405, along with tag 407. By manipulating the power of each of readers 405, e.g., by holding the power of two of readers 405 constant and decreasing the power transmitted by the remaining one of readers 405, it is possible to determine a distance from tag 407 to each reader of readers 405. Each such distance, designated as R1 409-1, R2 409-2, and R3 409-3, corresponds to the radius of a respective circle, designated as circle 411-1, 411-2, and 411-3, collectively circles 411. The point at which each of circles 411 meet corresponds to the location of tag 407, which can be determined by triangulation.

In some embodiments, when it is only desired to determine which reader is closest to the tag instead of the tag's actual location, fewer measurements may be taken. Further to this goal, the power output by each of readers 405 may be separately increased to find out to which reader the tag responded the most, i.e., by increasing its transmission rate the most. Again, the power of any others of readers 405 should be held constant.

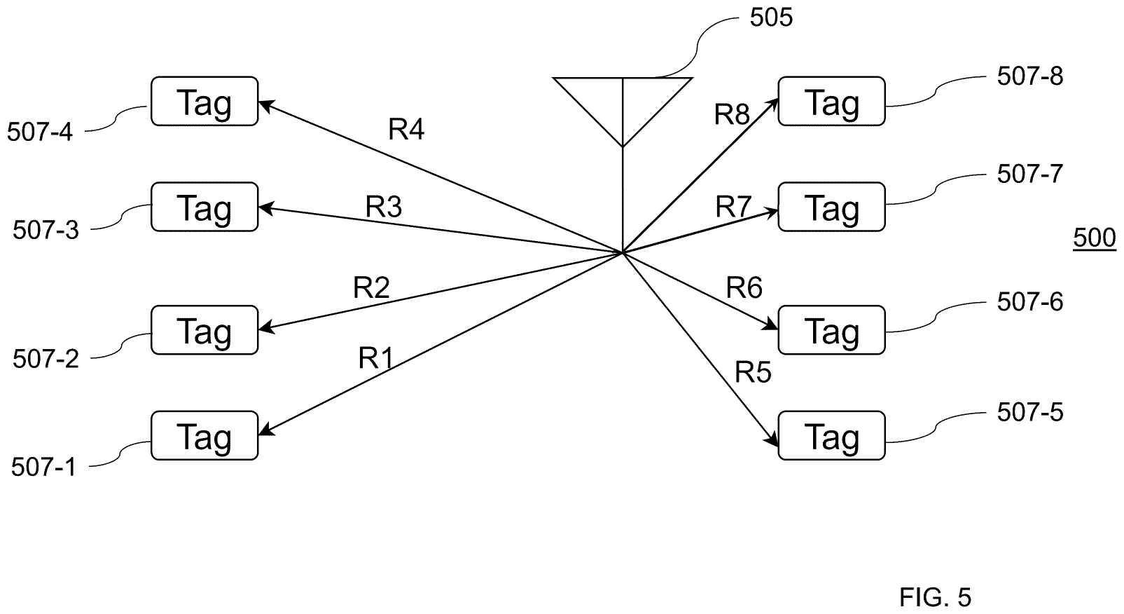

Using the principles described hereinabove, it is possible to arrange a system that includes multiple fixed-location tags from which the current location of a mobile reader is determined. Thus, shown in FIG. 5, is an arrangement 500 including mobile reader 505 and tags 507-1 through 507-8, collectively tags 507, each of which is stationed at a fixed location. At a particular point in time, the distance of each of tags 507-1 through 507-8 from reader 505, indicated as R1 to R8, is determined. Based on the distances, and given the known, fixed location of each of tags 507, a triangulation is performed to determine the location of reader 505. As reader 505 moves, the energizing power received by each of tags 507 will change, and hence so will their corresponding transmission rate. Thus, a new determination may be made along with a new triangulation to determine a new position for reader 505. Advantageously, this method does not require any synchronization amongst tags 507 as a tag's average transmission rate can be calculated even if not all of its packets are received at reader 505 and the transmission rate of each of tags 507 is independent of the transmission rate of any other of tags 507. Note that the transmission rate may be determined even if each transmitted packet is not received because each packet contains a packet or sequence number, and thus gaps in the numbering indicate packets that were transmitted but not received, as explained hereinabove. According to the principles disclosed herein, what is of interest is the number of packets transmitted, not the number received.

It is possible to have multiple moving readers amongst the fixed tags and each reader may be similarly located. In one embodiment, this may be implemented by coordinating the output power supplied by each reader. This can be coordinated by communication amongst the readers or by control from a controller, which may be cloud based. For example, the power of all of the readers but one may be reduced for a time period while measurements are taken, then the power of another is reduced for a subsequent time period, and so on. In another embodiment, other information, such as RSSI of the signal received from the tag, may be further employed in conjunction with the transmission rate to realize that the reader is very close to a particular tag.

As mentioned above, the channel loss may also be a function of, or at least impacted by, multipath channel interference, i.e., interference caused by one or more reflections of the transmitted signal. Such interference can corrupt the range estimation. For example, the power received by a tag may be reduced by cancellation as a result of at least one reflected version of the transmitted signal being somewhat out-of-phase with the desired signal and causing destructive interference therewith, reducing the effective energy received and hence reducing the tag's transmission rate, making the tag seem further away from the reader.

Given that channel loss is different for different channels, i.e., different frequencies, it is possible to perform the above-described techniques at more than one frequency to determine a channel loss for each one. The variously determined channel loss for each channel may then be combined, e.g., by taking the maximum packet transmission rate between them, taking the average, median, or different percentiles, or the like, to determine an overall channel loss to employ. Note that since what is being measured is the packet transmission rate, i.e., the rate at which the tag produces output packets, the different channels referred to herein are those used for the energizing of the tags, i.e., the frequencies that a tag harvests to power itself.

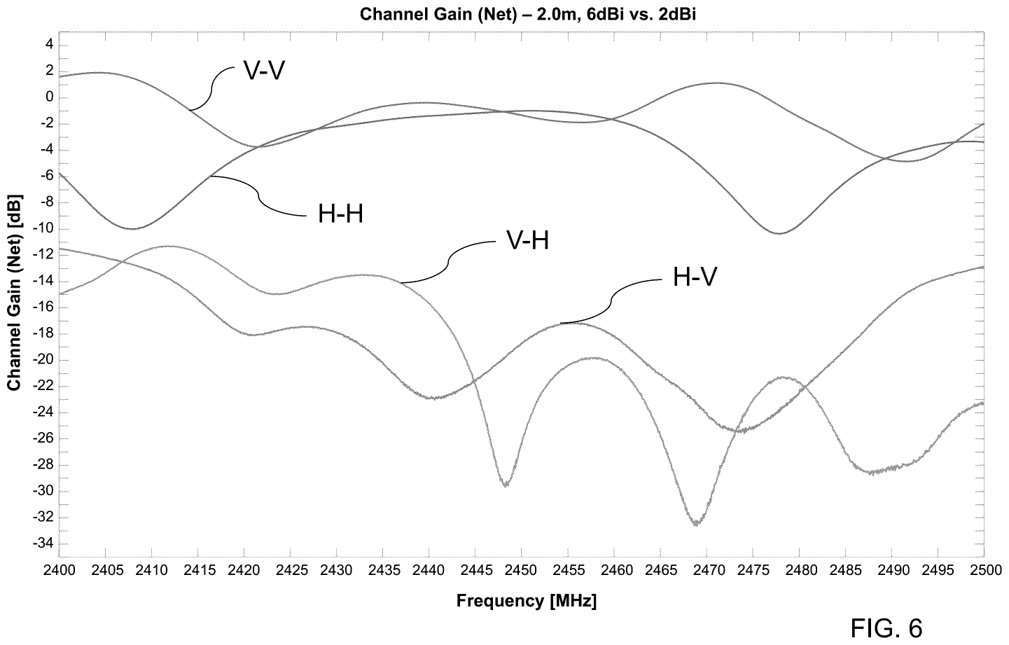

FIG. 6 shows an illustrative graph representing channel loss between one reader and one tag at different frequencies, where each curve represents a different a different antenna orientation, which also affects channel loss. The antenna orientations are H for horizontal and V for vertical, where the first listed in a pair is the reader antenna and the second listed in the pair is the tag antenna. Note that the channel loss is an estimated quantity based on the measured rate of transmissions using the techniques described hereinabove.

In operation, the measurements described hereinabove can be taken at the reader level and/or at the cloud level. In this regard, although not mentioned heretofore, the packets communicated from the tag to the reader may be encrypted. The decryption of such packets may take place at the reader or in the cloud.

Should reader level encryption be employed, i.e., where the reader is capable of decrypting the packets, the reader can calculate a packet rate for every tag from which it receives packets. Note that to determine the packet transmission rate that it is typically necessary to decrypt encrypted packets to be able to read the data from the tag, as such data includes packet transmission counters, i.e., a packet sequence number, which indicate which packet the packet is in a sequence of packets. Note that the packet sequence numbers may have a wrap-around, i.e., roll over to begin again.

When there is only one reader, the reader itself may implement the necessary logic for changing its own energizing power in order to perform the measurements. When there are multiple readers, the power levels employed by each must be coordinated, either by communication and cooperation amongst the readers or under the control of some type of controller, which may be located in the cloud.

Alternatively, decryption of the packets may be performed in the cloud by forwarding the packets to the cloud and information necessary to perform the methods disclosed herein may be returned to the readers or the methods performed in the cloud. At the cloud level, a tag's packet rate can be calculated from data in the cloud. In this regard, each packet transmitted by a tag may include a packet sequence number. The reader also uploads to the cloud a timestamp for each received packet which indicates when the packet was received by the reader.

Given that the respective locations of fixed-location readers, or the respective locations of fixed-location tags, are set by the implementer, these locations may be entered into and stored in a database. How the locations are represented is at the discretion of the implementer. In one embodiment, the readers may be equipped with global positioning system (GPS) readers to determine their own positions, which is entered into the database. In another embodiment, the implementer may determine the location of a reader or a tag by using a handheld GPS unit that is held adjacent to the reader or tag. In yet another embodiment, coordinates may be defined within an area, e.g., a building, a courtyard, a city, and the like, and the coordinates at which a reader or tag is located may be specified as the location.

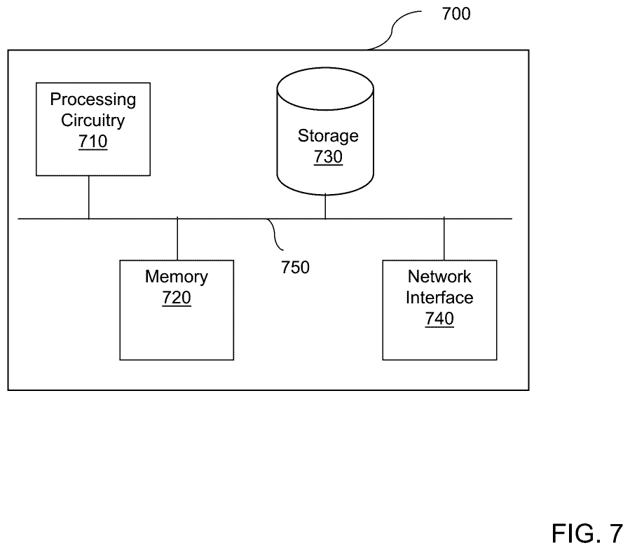

FIG. 7 is an example schematic diagram of a system 700 according to an embodiment that could be used to implement a reader or a server of a cloud environment for use in implementing the above-described arrangements. The system 700 includes a processing circuitry 710 coupled to a memory 720, a storage 730, and a network interface 740. In an embodiment, the components of the system 700 may be communicatively connected via a bus 750.

The processing circuitry 710 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 720 may be volatile, e.g., random access memory, etc., non-volatile, e.g., read only memory, flash memory, etc., or a combination thereof.

In one configuration, software for implementing one or more embodiments disclosed herein may be stored in the storage 730. In another configuration, the memory 720 is configured to store such software. Software shall be construed broadly to mean any type of instructions, whether referred to as software, firmware, middleware, microcode, hardware description language, or otherwise. Instructions may include code, e.g., in source code format, binary code format, executable code format, or any other suitable format of code. The instructions, when executed by the processing circuitry 710, cause the processing circuitry 710 to perform the various processes described herein.

The storage 730 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 740 allows the system 700 to communicate with, for example, a wireless tag, e.g., if system 700 is used to implement a reader, and may also be used to communicate with the cloud. When system 700 implements a server in the cloud, network interface 740 allows the server to communicate with one or more readers. In this regard, network interface 740 may include one or more wired transceiver circuits or wireless transceiver circuits and appropriate antennas.

It should be understood that the embodiments described herein are not limited to the specific architecture illustrated in FIG. 7, and other architectures may be equally used without departing from the scope of the disclosed embodiments.

System 700 may be implemented in whole or in part as a virtual machine.

Note that wherever a signal that is transmitted from a transmit antenna is referred to, in systems without antennas such phraseology may be considered to refer to signal supplied to a transmit branch.

Likewise, wherever a signal that originates at a receive antenna is referred to, in systems without antennas such phraseology may be considered to refer to a signal arriving at a receive branch.

The various embodiments disclosed herein can be implemented as hardware, firmware, firmware executing on hardware, software, software executing on hardware, or any combination thereof. Moreover, the software is implemented tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

1. A method for determining a location of a battery-less wireless tag by a tag reader being at a fixed-location, comprising:
transmitting, by the tag reader, at least one wireless signal having a controlled known energy;
receiving at the tag reader at least one packet transmitted by the tag within a time window; and
responsive to a determination at the tag reader of at least one transmission rate of packets by the wireless tag based on the at least one received packet, determining information regarding the location of the tag.

2. The method of claim 1, wherein the transmitting of the at least one wireless signal having the controlled known energy, which is a first energy, is performed during the time window, the method further comprising:
transmitting during the time window by at least one additional tag reader at least one additional wireless signal having a controlled, known second energy, wherein the at least one transmission rate of packets includes a first transmission rate by the wireless tag that is determined based the at least one packet received from the wireless tag for the time window;
transmitting, by the tag reader, at least a second wireless signal having a controlled known third energy during a second time window;
transmitting, during the second time window, by the at least one additional tag reader, at least an additional second wireless signal having a controlled, known fourth energy, wherein at least one of the first energy, second energy, third energy, and fourth energy is different from the energy of the others of the first energy, second energy, third energy, and fourth energy and wherein each of the first energy, second energy, third energy, and fourth energy is an energy that is zero or greater, wherein the transmission rate of packets by the wireless tag during the second time window is determined based on at least one packet received from the wireless tag during the second time window and is a second transmission rate; and
wherein the at least one transmission rate of packets further includes the second transmission rate.

3. The method of claim 1, wherein the fixed location of the tag reader is a known location.

4. The method of claim 1, wherein the transmission rate of packets is determined based on a packet number in each of the at least one received packet.

5. The method of claim 1, wherein the transmission rate of packets is determined based on a packet number in at least one received packet in a prior time window.

6. The method of claim 1, wherein the information regarding location of the tag is based on a channel loss between the wireless tag and the tag reader, wherein the channel loss is based on at least on the wireless tag's transmission rate versus channel loss characteristic and the transmission rate of packets.

7. The method of claim 1, wherein the transmission rate of packets by the wireless tag is determined based on packets received during the time window.

8. The method of claim 1, wherein the battery-less wireless tag is moveable with respect to the tag reader.

9. A method for determining a location of a battery-less wireless tag with respect to at least one tag reader of a plurality of tag readers, comprising
transmitting by each of the plurality of tag readers an energizing signal for the battery-less wireless tag during each of a plurality of time windows, wherein the energizing signal transmitted by each respective one of the plurality of tag readers is transmitted with its own a prescribed energy, wherein each respective prescribed energy is zero or greater, wherein the prescribed energy of at least one of the energizing signals in at least one of the time windows is changed with respect to one of the time windows preceding the at least one of the time windows; and
determining a location of the battery-less wireless tag based on a transmission rate of the battery-less wireless tag in each of at least two of the time windows which include the at least one of the time windows and the one of the time windows preceding the at least one of the time windows.

10. The method of claim 9, wherein the location of the battery-less wireless tag is determined with respect to at least one tag reader of a plurality of tag readers.

11. The method of claim 9, wherein there are at least three tag readers in the plurality and wherein the location of the tag is further based on triangulation when the at least three tag readers have a known location.

12. The method of claim 9, wherein transmission rate of the battery-less wireless tag is determined based on a packet number in each of at least one received packet received from the wireless tag during each of the at least two of the time windows.

13. The method of claim 9, wherein the battery-less wireless tag is moveable with respect to the tag reader.

14. A method for determining a location a of battery-less wireless tag by correlating a transmission rate of the battery-less wireless tag with at least one change in the transmit power level of at least one energizing signal transmitted by a respective at least one tag reader.

15. The method of claim 14, wherein the battery-less wireless tag is moveable with respect to the tag reader.

16. A method for determining a location of a mobile tag reader in an area containing a plurality of battery-less wireless tags that each have a known fixed location, comprising:
transmitting, by the mobile tag reader, during a time window, at least one wireless signal having a controlled known energy;
receiving at the mobile tag reader at least one packet transmitted by each of one or more of the wireless tags within the time window; and
responsive to a determination at the mobile tag reader of a transmission rate of packets from each of the one or more wireless tags of the plurality, which is based on the at least one packet received from each of the one or more of the wireless tags, determining a location of the mobile tag reader.

17. The method of claim 16, wherein the transmission rate of packets from each of the one or more wireless tags of the plurality is determined based on a packet number in the at least one packet received from each of the one or more of the wireless tags.

18. The method of claim 16, wherein there are at least three battery-less wireless tags in the plurality and wherein the location of the mobile tag reader is further based on triangulation with respect to the known fixed location of at least three of the battery-less wireless tags.

19. A system for determining a location of a battery-less wireless tag, comprising:
a processing circuitry; and
a memory, the memory containing instructions that, when executed by the processing circuitry, configure the system to:
transmit at least one wireless signal having a controlled known energy;
receive at least one packet transmitted by the tag within a time window; and
responsive to a determination of at least one transmission rate of packets by the wireless tag based on the at least one received packet, determine information regarding the location of the tag.

20. A system for determining a location of a mobile tag reader in an area containing a plurality of battery-less wireless tags that each have a known fixed location, comprising:
a processing circuitry; and
a memory, the memory containing instructions that, when executed by the processing circuitry, configure the system to:
transmit, during a time window, at least one wireless signal having a controlled known energy;
receive at the mobile tag reader at least one packet transmitted by each of one or more of the wireless tags within the time window; and
responsive to a determined transmission rate of packets from each of the one or more wireless tags of the plurality, which is based on the at least one packet received from each of the one or more of the wireless tags, determine a location of the mobile tag reader.
